(19) United States
(12) Patent Application Publication
(10) Pub. No.: US 2023/0206088 A1
(43) Pub. Date: Jun. 29, 2023

(54) COGNITIVE SELECTION OF COMPOSITE SERVICES

(71) Applicant: KYNDRYL, INC., New York, NY (US)

(72) Inventors: Shashidhar Sastry, Pune (IN); Rahul Chenny, BANGALORE (IN)

(21) Appl. No.: 17/563,113

(22) Filed: Dec. 28, 2021

(51) Int. Cl. G06N 5/04

(52) U.S. Cl. CPC G06N 5/04

(57) ABSTRACT

A method includes receiving training inputs related to technology use cases and associated services, training, by a cognitive integration engine a cognitive model from the received training inputs, receiving a demand for composite services from a customer including functional and/or non-functional requirements, determining, by the cognitive integration engine, a selection of composite services for the customer based on the cognitive model, and recommending the selection of composite services to the customer.

### BACKGROUND

The present invention relates to methods for cognitively selecting composite services. More specifically, the invention relates to systems and methods for cognitive selection and/or importance scoring of IT service and product assets based on requirements, asset characteristics and multivariate outcomes. The present invention provides systems and methods capable of generating a contextual technical services hierarchy based on technical use case requirements.

Continuous disruptions in business as a result of digital transformation and events such as COVID-19 continue to create market shifts. Furthermore, technology shifts also create “Quality of Service” differentiation. Businesses are reacting by demanding a shorter runway (time continuum) for rapid adaptation and innovating across products and services. New IT services-aligned businesses are being created. Additionally, existing services are being enhanced. This includes service assets in various categories including Advisory Services, Build Services, Manage Services, and Migrate Services. Each of these high-level services can be further broken up into many child-level services. For example, within Manage Services, there may be Manage Services for Public Cloud Infrastructure, Manage Services for Private Cloud Infrastructure, and the like. These child-level services may be specific or limited in scope such that every child-level service may not benefit every customer. Addressing customer needs from available services may take considerable time and effort to coherently package available services for consumption.

### SUMMARY

An embodiment of the present invention relates to a method, and associated computer system and computer program product, for cognitive selection of composite services and product assets. In accordance with the method one or more processors of a computer system receive training inputs related to technology use cases and associated services. A cognitive engine of the one or more processors of the computer system train a cognitive model from the received training inputs. The one or more processors of the computer system receive a demand for composite services from a customer including functional and/or non-functional requirements. The cognitive integration engine of the one or more processors of the computer system determine a selection of composite services for the customer based on the cognitive model. The one or more processors of the computer system recommend the selection of composite services to the customer.

### BRIEF DESCRIPTION OF THE DRAWINGS

FIG. 1 depicts a process flow 100 for a method for cognitive selection of cognitive services, in accordance with embodiments of the present invention.

FIG. 2 depicts an exemplary model breaking up composite assets into assets and service catalogue API assets, in accordance with embodiments of the present invention.

FIG. 3A depicts a constructs chart of a portion of a services hierarchy, in accordance with embodiments of the present invention.

FIG. 3B depicts a constructs chart of another portion of the services hierarchy of FIG. 3A, in accordance with embodiments of the present invention.

FIG. 4 depicts an architectural framework of a system for cognitive selection of composite services, in accordance with embodiments of the present invention.

FIG. 5 depicts a system for cognitive selection of composite services, in accordance with embodiments of the present invention.

FIG. 6 depicts a hierarchy diagram displayed by a cognitive integration engine of the system for cognitive selection of composite services of FIG. 5, in accordance with embodiments of the present invention.

FIG. 7 depicts a schematic view of the cognitive integration engine of the system for cognitive selection of composite services of FIG. 5, in accordance with embodiments of the present invention.

FIG. 8 depicts a method for cognitive selection of composite services, in accordance with embodiments of the present invention.

FIG. 9 depicts a block diagram of a computer system for the system and engine of FIGS. 4, 5 and 7, capable of implementing methods such as those of FIGS. 1 and 8, in accordance with embodiments of the present invention.

FIG. 10 depicts a cloud computing environment, in accordance with embodiments of the present invention.

FIG. 11 depicts abstraction model layers, in accordance with embodiments of the present invention.

### DETAILED DESCRIPTION

The present invention recognizes that addressing client or customer needs for selecting composite services requires identifying sequencing and stitching multiple relevant services together to form a combination of services that satisfies the client or customer. Furthermore, it takes considerable effort to coherently package these services for consumption. As market and technology shifts require re-integrating individual services as new services are being introduced on a regular basis. Furthermore, the number of lower level (e.g. child level) services could vary but may be several per upper level (e.g. parent level) services. For ten parent services with ten children services, the number of total services for evaluation can be large. Each permutation of service selection needs to be evaluated for relevance and must address a business need or use case.

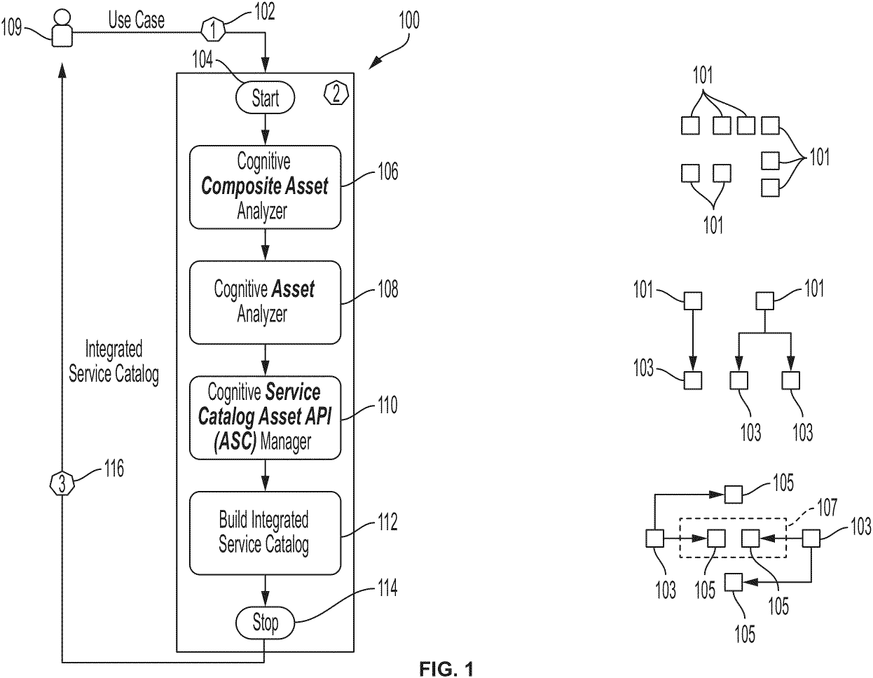

FIG. 1 depicts a process flow 100 for a method for cognitive selection of cognitive services, in accordance with embodiments of the present invention. As shown, the process flow 100 includes inputting data or information related to a use case 102 into a cognitive integration engine and starting the method 100 at a step 104. It should be understood that the cognitive integration engine may already be trained at the time of the method, in accordance with the methods described hereinbelow. Upon receiving information related to the use case 102, the cognitive integration engine may utilize a cognitive composite asset analyzer at a step 106 to analyze cognitive composite assets related to the use case. At this step, the cognitive composite asset analyzer analyzes the use case to identify matching composite assets 101, and performs an “affinity pattern” analysis to map the composite assets 101, as described in more detail herein below.

Next, the cognitive integration engine may utilize a cognitive asset analyzer at a step 108. For each of the composite assets 101, relevant assets 103 are selected. The relevant asset selection may be based on cognitive analysis and machine learning on the cognitive integration engine. At a next step 110, a cognitive asset service catalogue (ASC) manager of the cognitive integration engine is used to identify related ASCs 105 between two or more relevant assets 103. The ASCs 105 are shown as a relation 107. Such a comparative analysis may be performed at this step 110 for each relevant asset 103. Next, a step 112 includes building an integrated service catalogue, which may include one or more sets of catalogues or solutions. This integrated service catalogue may be provided back to a user 109 at a step 116.

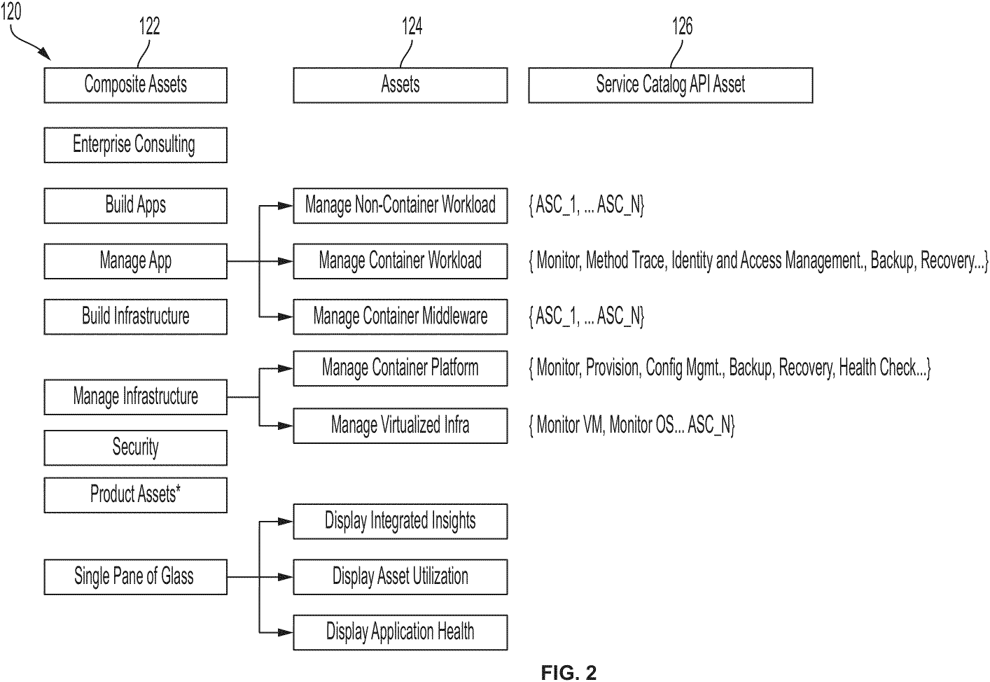

FIG. 2 depicts an exemplary model 120 breaking up composite assets 122 into assets 124 and service catalogue API assets 126, in accordance with embodiments of the present invention. The model 120 shows an example of types of information technology (IT) services and product information. In the example provided, the composite assets 122 include enterprise consulting, build applications, manage applications, build infrastructure, manage infrastructure, security, product assets, single pane of glass consoles.

As shown, the various composite assets 122 may include specific assets 124. For example, the manage application composite asset is shown to include the various specific assets including a manage non-container workload asset, a manage container workload asset, and a manage container middlewear asset. Similarly, the manage infrastructure asset is shown including a manage container platform asset, and a manage virtualized infrastructure asset. Finally the single pane of glass console composite asset includes a display integrated insights asset, a display asset utilization asset, and a display application health asset. While three of the composite assets 122 are shown having specific assets 124 in the embodiment shown, it should be understood that each of the composite assets 122 may include any number of specific assets 124. Moreover, the composite assets 122 shown having specific assets 124 may include additional specific assets 124 not shown.

Further, examples of service catalogue API assets 126 are shown for each of the specific assets 124. For example, the manage container workload asset is shown having service catalogue API assets including a monitor service catalogue API asset, a method trace service catalogue API asset, an identity and access management service catalogue API asset, and a recovery service catalogue API asset. Again, any specific asset 124 may include any number of service catalogue API assets, and the examples shown are meant to be exemplary but not limiting.

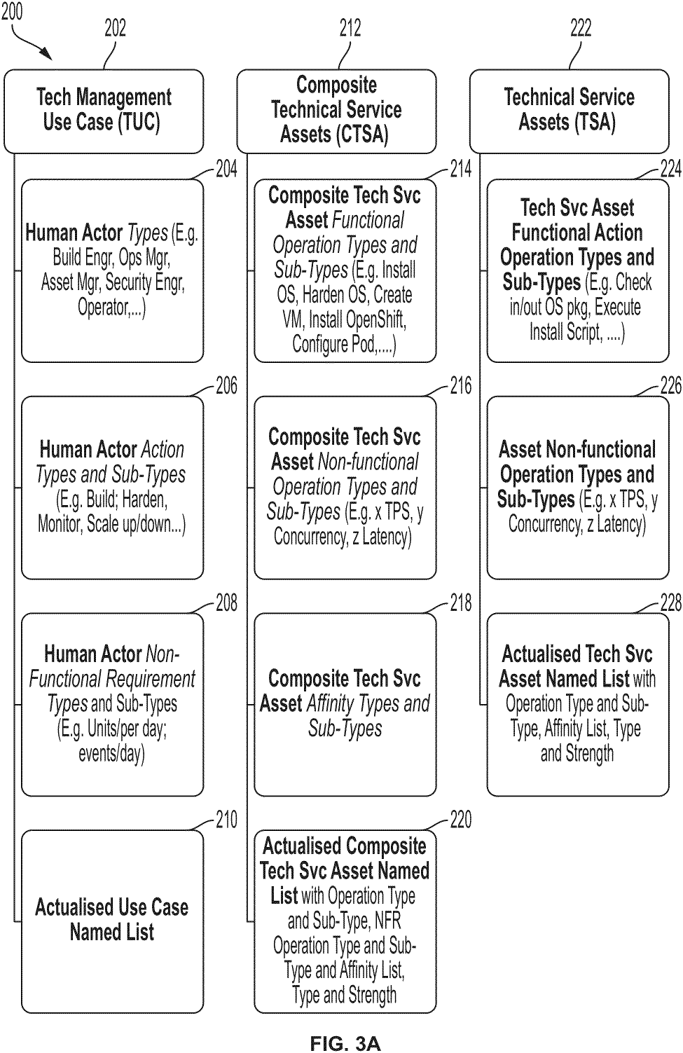

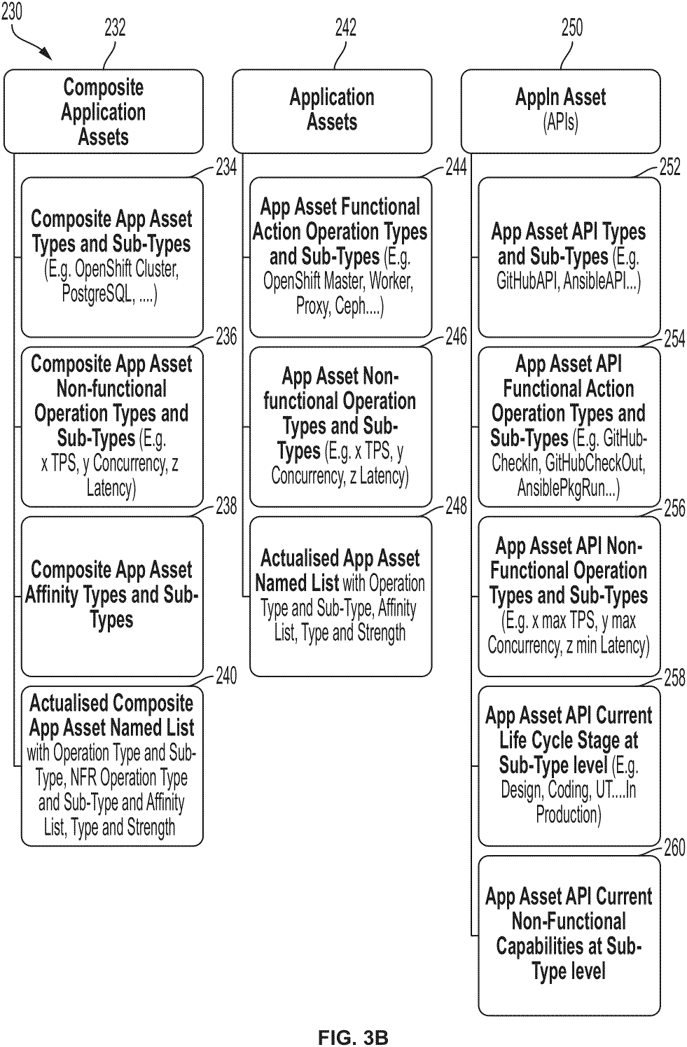

FIG. 3A depicts a constructs chart 200 of a first portion of a services hierarchy, in accordance with embodiments of the present invention. The constructs chart 200 includes information which may be stored related to various categories in a services hierarchy, including tech management use cases (TUC), composite technical services assets (CTSA) and technical service assets (TSA).

For example, tech management use cases (TUC) 202 may include information related to types or categories of human actors 204 such as building engineers, ops managers, asset managers, security engineers, operators or the like. TUC information may further include action types 206 taken by human actors associated with the TUC, such as build, harden, monitor, scale up or down, or the like. TUC information may further include human actor non-functional requirement types and subtypes 208 such as units per day, events per day or the like. TUC information may still further include actualized use case named list 210, which may be used in language analysis machine learning systems of the cognitive integration engine described herein.

Another category in a services hierarchy shown is composite technical service assets (CTSAs) 212. Examples of information related to CSTAs 212 may be the functional operation types and sub-types of the CTSA 214. By way of example, functional operation types may include install operating system, harden operating system, create virtual machine, install OpenShift, Configure Pod, or the like. CTSA information may further include CTSA non-functional operation types and subtypes 216, such as transaction processing systems, concurrency or latency requirements. CTSA information may further include affinity types and subtypes 218. CTSA information may further include actualized CTSA named list 220, which may be used in language analysis machine learning systems of the cognitive integration engine described herein. Actualized CTSA named list 220 information may include operation type and sub-type, nonfunctional requirement operation type and sub-type and affinity list, type and strength information.

Another category in a services hierarchy shown is technical service assets (TSAs) 222. Examples of information related to TSAs 222 may be the functional action operation types and sub-types of the TSA 224. By way of example, functional action operation types may include check in/out operating system package, execute install script, or the like. TSA information may further include TSA non-functional operation types and subtypes 226, such as transaction processing systems, concurrency or latency requirements. Actualized technical service asset named list information 228 may include operation type and sub-type, affinity list, type and strength information.

FIG. 3B depicts a constructs chart 230 of another portion of the services hierarchy of FIG. 3A, in accordance with embodiments of the present invention. The constructs chart 200 includes more information which may be stored related to various categories in a services hierarchy, including composite application assets (CAA) 232, application assets (AA) 242, and application programming interfaces 250.

For example, the composite application assets 232 may include composite application assets non-functional types and sub-types 234. The composite application assets non-functional types and sub-types 234 may include open shift cluster information, PostgreSQL information, and the like. Composite application assets 232 information may include composite application asset non functional operation types and sub-types 236. The composite application asset non functional operation types and sub-types 236 may include information related to transaction processing systems, concurrency or latency requirements. Composite application assets 232 information may include composite application asset affinity types and sub-types 238. Composite application assets 232 information may still further include actualized composite application asset named list information 240 that may include operation type and sub-type, affinity list, type and strength information.

Another category in the services hierarchy shown is application assets 242. Examples of information related to the application assets 242 may include application asset functional action operation types and sub-types 244 such as OpenShift Master, Worker, Proxy, and Ceph storage. Application assets 242 may include application asset non-functional operation types and sub-types 246, such as transaction processing systems, concurrency or latency requirements. Application assets 242 information may still further include actualized application asset named list information 248 that may include operation type and sub-type, affinity list, type and strength information.

Finally, the services hierarchy may include information related to application programming interface information 250. Examples of information related to application programming interfaces may include application asset API types and sub-types 252 such as GitHubAPI, AnsibleAPI, and the like. Examples of information related to application programming interfaces may further include application asset API functional action operation types and sub-types 254 such as GitHubCheckIn, GitHubCheckOut, AnsiblePkgRun, and the like. Examples of information related to application programming interfaces may further include application asset API non-functional operation types and sub-types 256, such as transaction processing systems, concurrency or latency requirements. Still further examples of information related to application programming interfaces may include Application Asset API Current Life Cycle Stage at Sub-type level 258 information including, for example, design information, coding information, and the like. Finally, examples of information related to application programming interfaces may include Application Asset API Current Non-Functional Capabilities at Sub-Type level 260.

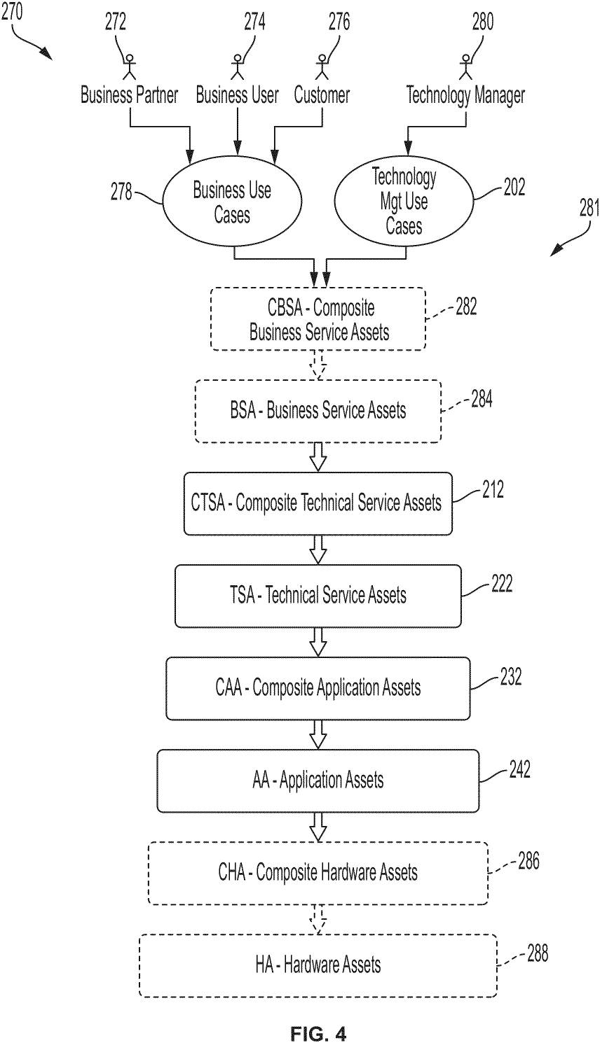

FIG. 4 depicts an architectural framework 270 of a system for cognitive selection of composite services, in accordance with embodiments of the present invention. The architectural framework 270 includes one or more business partners 272, one or more business users 274, and one or more customers 276 providing information related to business use cases 278. A technology manager 280 is further shown providing information related to the technology management use cases 202 (described by way of example hereinabove). The building blocks of composite services is shown including architecture related to the business use cases 278 and the technology management use cases 202. While the example information shown in FIGS. 3A and 3B may outline the constructs of the technology management use cases 202, it should be understood that the present invention may be deployed for cognitively selecting composite services related to both the technology management use cases 202 and the business use cases 278.

The information related to business use cases 278 and technology management use cases 202 may be provided to the cognitive integration engine of the present invention as described herein. A hierarchy 281 is shown which represents the building blocks of the functional and nonfunctional requirements at various service levels in a service architecture of a system having both technology and business requirements and use cases. The lower-level services on the hierarchy 281 become more and more specific relative to the upper-level services.

The hierarchy 281 of information is shown including composite business service assets 282 as well as business services assets 284, each related to the business use cases 278. For example, the composite business service assets 282 may include risk management services, for example, while the business services assets 284 may include technical security management information.

The hierarchy 281 further includes technology management use case information related to technology management use cases 202 such as the composite technical service assets 212 (e.g. threat management service information), the technical service assets 222 (e.g. (threat detection services, threat prevention services, threat prediction services), the composite application assets 232 (e.g. threat dashboard services, log management systems), and the application assets 242 (e.g. threat monitoring services, vulnerability management services, alerting services). These types of services are also described hereinabove with respect to FIGS. 3A and 3B.

Further, the hierarchy 281 includes information related to hardware. Such information may include composite hardware assets 286 (e.g. IDAM server information, lightweight directory access protocol information, log management server information, and notification server information). Finally, the hierarchy 281 includes information related to hardware assets 288. The hardware information may be related to either or both the business use cases 278 or the technology management use cases 202.

By way of example, the present invention contemplates a business use case that comprises a retail customer actor where the system receives various inputs and processes those inputs to determine a CTSA that includes TSAs, CAAs and AAs. Here, the CTSA may be a service allowing the retail customer actor to search for products by keyword, part number, supplier and/or price range and may be composed of Catalog, Order Management TSAs or the like. A function sub-type for this example may be the ability to sort the search results by a specified attribute. Non-functional requirements may include the ability to search 500 transaction processing systems, with 50,000 simultaneous sessions, with 100% latency within 3 seconds and 90% within 1 second, with 99.9% availability. Composite application asset information output related to the retail customer project may include a composite application asset of a sales system which includes assets such as systems related to an Enterprise Product Catalogue (EPC), Order Management, Billing & Invoicing, Payments, Collections, Credit Management, and Loyalty Management. The sales system may further include Affinities such as Marketing System, an Enterprise Resource Planning (ERP) System, and a Management Information System (MIS). Application assets output in this example may include an Engineering, Procurement & Construction asset having APIs such as Product APIs, Partner APIs, Price related APIs, billing and invoicing APIs and the like. Additional APIs output in this example may include Product APIs which include the ability to search products by keyword, part number, supplier, price range, and sort products by result set and attribute. These APIs may include non-functional capabilities, consistent with requirements.

Thus, as a whole the system for cognitive selection of composite services may include a cognitive integration engine which receives various informational inputs including but not limited to technology use cases with function points and non-functional requirements. The informational inputs may further include lists of available and planned CTSA, TSA, CAA, and AA. The list of informational inputs may still further include lists of available APIs, lists of planned API’s, and cognitive training inputs for asset identification and prioritization.

In practice the cognitive integration engine of the cognitive selection of composite services may be configured to perform various processes. First, the cognitive integration engine may be configured to match use case functions and non-functional requirements by traversing top down along a hierarchy of services to reach API operations and non-functional requirements to find the best service and application asset matches cognitively. The cognitive integration engine may further prioritize the service and application assets cognitively, and may be configured to choose the more complete API and higher mutual affinities where there is more than one option. From the selected assets, the cognitive integration engine may be configured to cognitively create the final list of integrated services to deliver the use cases.

Outputs by the cognitive integration engine may take the form of an integrated composite technical service asset (CTSA) list for a use case, or group of lists sorted by use case, as well as integrated technical service assets (TSA) lists for the CTSAs. Outputs may further include a service-wise API and composite application asset (CAA) list, as well as an application asset (AA) list for the CAAs. Outputs may further include available, planned or missing API operations, functional completeness and/or scoring for outputs, and non-functional requirements completeness or scoring.

### Example Technology Use Case

In one exemplary technology use case whereby composite services relate to sending a proposed configuration change to a microservice running in one or more pods for approval to an operational manager. The nonfunctional requirements specify that the microservice must support 400 transactions per day with a maximum latency for the change as 10 milliseconds.

### Stage 1 - Finding Matching Available and Planned CTSAs and TSAs

At stage one, the cognitive integration engine of the cognitive selection of composite services may take the first Technical Management Use Case (TUC) and parse the Use Case Function Points (UCFPs) of the technical management use case and find the key words. Next the the cognitive integration engine may parse the CTSA names and attributes to find the best matches, using text analytics models. Text analytics models may include text and phrase matching using Levenshtein Distance, Jaro-Winkler Algorithm, Cosine and Trigram. Common pre-processing includes Word Tokenization, Parts-Of-Speech Tagging, Stopwords, Lexicon Normalization, Stemming (linguistic normalization), etc may also be used. Next, for the best match CTSAs, the cognitive integration engine may parse the TSA and down to the Appln Assets i.e. API names and attributes. For the best match APIs, the cognitive integration engine may parse the operation names and attributes to find the best matches to the UCFP names and attributes. Next, for the best match APIs, the cognitive integration engine may parse the Non-Functional Capabilities to best match the UCFP NFRs. Finally, the cognitive integration engine may produce the match list of available and planned CTSAs, TSAs and APIs with completeness of Function Point and NF Requirements for use in the next stage.

### Stage 2 - Define Proposed CTSAs, TSAs and APIs for Missing/Partial Operations in Available/Planned CTSAs and TSAs

At the second stage, for function points that have no matches or incomplete matches to UCFPs, the cognitive integration engine of the cognitive selection of composite services may parse Technical Service Assets (TSAs) names and attributes to find the best matches, using text analytics models. For the best match TSAs, the cognitive integration engine may parse through the layers down to the Application Assets i.e. API names and attributes to find the best matches to UCFP names and attributes. For the best match APIs, the cognitive integration engine may then parse the operation names and attributes to find the best matches to the UCFP names and attributes. For the best match APIs, the cognitive integration engine may parse the Non-Functional Capabilities to best match the UCFP NFRs. The cognitive integration engine may then produce the match list with completeness of Function Point and NF Requirements. For each TSA and its APIs and their operations in the list, the cognitive integration engine may go through all the other TSAs and parse the Affinity Types, Lists and Strengths to find strong correlated operations. The best correlated operations (either single ones on TSAs or across TSAs) comprise the CTSAs (aka Integrated Services) required for the UCFPs. For each TUC, the cognitive integration engine may show a percent satisfaction of FRs and NFRs by the available and planned CTSAs. For each CTSA and TSA, the cognitive integration engine may further show the attributes for each API Operation (e.g. Status — Available/Planned/Proposed; Enhancement - Scaling Type - Exact/Scale Up/Scale Down, Scaling Amount - 0/+X%/-Y%). The cognitive integration engine may show this entire landscape to the Technology manager for short and long term use.

### Integrated Application Assets Identification Algorithm

For the use case, an algorithm may be used by the cognitive integration engine for asset identification. For each TUC and its available/planned CTSA and TSA, the cognitive integration engine may list the corresponding Composite Application Assets (CAAs) and Application Assets (AAs). For each TUCs Available and Planned CAA and AA, the cognitive integration engine may list the following attributes: Scaling Type - Exact/Scale Up/Scale Down, Scaling Amount - 0/+X%/-Y%. For each proposed CTSA and TSA the cognitive integration engine may identify the APIs and Operations Required. The cognitive integration engine may parse the proposed operation names and attributes find affinities and define the proposed APIs. From the proposed API names and attributes, the cognitive integration engine may find affinities and define the proposed AAs. From the proposed AA names and attributes, the cognitive integration engine may find affinities and define the proposed CAAs. For the proposed AAs, the cognitive integration engine may show the required NFR capabilities. The cognitive integration engine may further display the entire list of available, planned and proposed CAAs and AAs and with all the above attributes to the technology manager for further use.

The cognitive integration engine may utilize various forms of machine learning to continuously improve rules, in accordance with the invention described herein and consistent with the Example Technology Use Case. The cognitive integration engine may apply machine learning when a new function is added to an API to determine which use cases is it applicable to (i.e. a classification problem). The cognitive integration engine may use machine learning when more capacity is required in one function, in order to determine how much more capacity is required in a related function (i.e. a regression problem). Further, machine learning may be deployed by the cognitive integration engine to determine where a new function should be placed when there are more than one service assets that are suitable for it (i.e. a classification problem).

All three machine learning types--supervised, unsupervised and reinforcement learning-can be used for problems of the above nature. Out of the common machine learning algorithms--Linear Regression, Logistic Regression, Decision Tree, SVM, Naive Bayes, kNN, K-Means, Random Forest, and Dimensionality Reduction Algorithms, the ones most useful for our invention are: Linear Regression, Naive Bayes and Decision Tree.

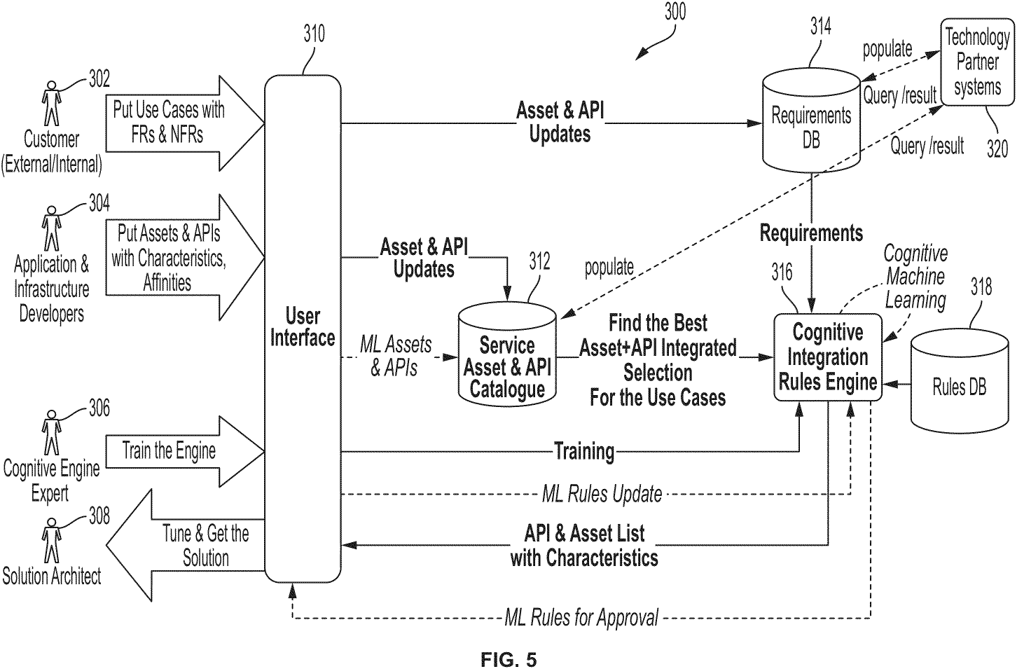

FIG. 5 depicts a system for cognitive selection of composite services 300, in accordance with embodiments of the present invention. The system for cognitive selection of composite services 300 may be provided inputs by a customer 302 (which may be internal or external to the system 300), an application and infrastructure developer 304, a cognitive engine expert 306, and a solution architect 308. The users 302, 304, 306, 308 may be configured to interact with the system 300 via a user interface 310. For example, the customer 302 may provide the system with use cases with functional requirements and nonfunctional requirements. The application and infrastructure developer 304 may provide the system with information related to assets and APIs, including characteristics and affinities thereof. The cognitive engine expert 306 may interact with the system 300 to facilitate training of a cognitive integration engine 316 of the system 300. The solution architect 308 may be a user who is provided a recommended solution by the system 300 and the cognitive integration engine 316 of the system 300. In particular, the cognitive engine expert 306 may provide machine learning rules updates to the cognitive integration engine 316 via the user interface 310. The cognitive integration engine 316 may provide machine learning rules back to the cognitive engine expert 306 via the user interface 310.

As shown, the system 300 includes various databases for storing information including a service asset and API catalogue database 312, a requirements database 314, and a rules database 318. These various databases 312, 314, 316 may each be in operable communication with the cognitive integration engine 316. In particular, the service asset & API catalogue database 312 may be provided with Asset & API updates and machine learning assets and APIs over the user interface 310 by the various users 302, 304, 306, 308. Similarly, asset and API update information may be provided to the requirements database 314 of the user interface 310 by the various users 302, 304, 306, 308. Technology partner systems 320 may also provide information to populate the requirements database 314 and the service asset & API catalogue database 312. The rules database 318 may store machine learning rules created by the cognitive integration engine 316 as facilitated by the interaction with the cognitive engine expert 306.

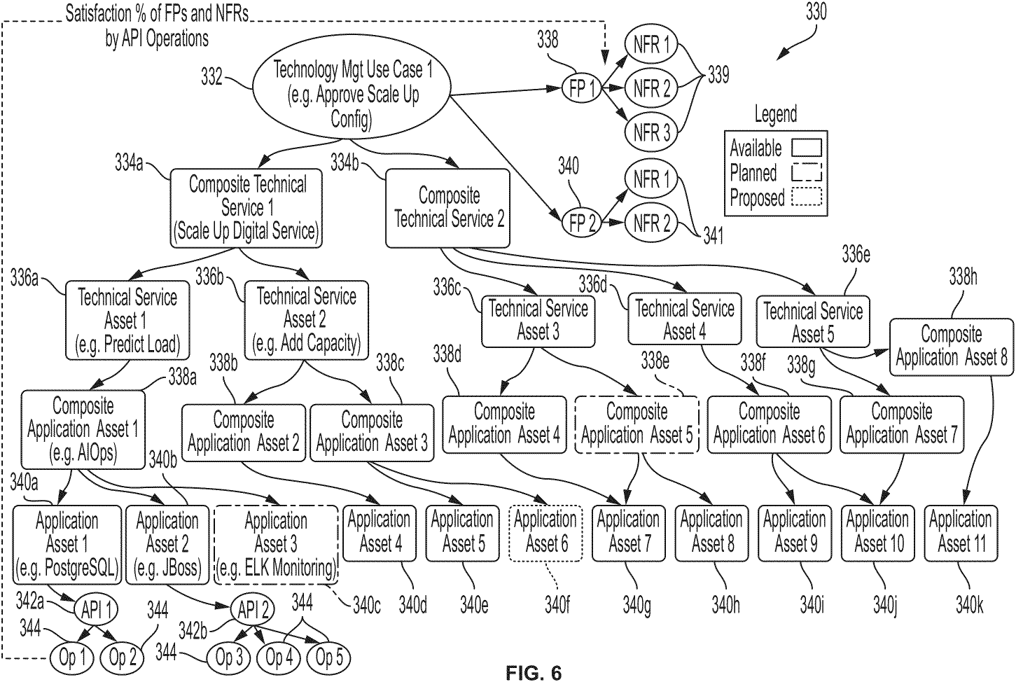

FIG. 6 depicts a hierarchy diagram 330 displayed by the cognitive integration engine 316 of the system for cognitive selection of composite services 300 of FIG. 5, in accordance with embodiments of the present invention. As shown, the hierarchy diagram 330 includes an exemplary technology management use case 332 (e.g. approving a scale up configuration), which includes a first functional point 338 having a first set of non-functional requirements 339, and a second functional point 340 having a second set of non-functional requirements 341. The technology management use case 332 includes two composite technical services 334a, 334b, one of which being a scale up digital service. The composite technical services 334a, 334b further include a plurality of technical service assets 336 associated therewith. In particular, the first composite technical service 334a includes a first technical service asset 336a (e.g. a predict load asset), and a second technical service asset 336b (e.g. an add capacity asset). The second composite technical service 334b includes a third technical service asset 336c, a fourth technical service asset 336d, and a fifth technical service asset 336e. The various technical service assets 336 each include one or more composite application assets 338a, 338b, 338c, 338d, 338e, 338f, 338g, 338h. The composite application assets 338a, 338b, 338c, 338d, 338e, 338f, 338g, 338h each include one or more application assets 340a, 340b, 340c, 340d, 340e, 340f, 340g, 340h, 340i, 340j, 340k. Finally, as shown the first application asset 340a includes a first API 342a, and the second application asset includes a second API 342b. However, it should be understood that the various application assets 340 may each include one or more APIs. The two APIs 342a, 342b each include a plurality of operations 344. The cognitive engine may be configured to determine the appropriate services, all the way down to the various API operations, and provide a satisfaction percentage related to accomplishing or meeting the functional points 338, 340 and non-functional requirements 339, 341. The hierarchy diagram 330 further shows that some of the various services are available, while others may be planned or proposed and not yet available to be offered as a solution to meet the functional points or non-functional requirements of a use case.

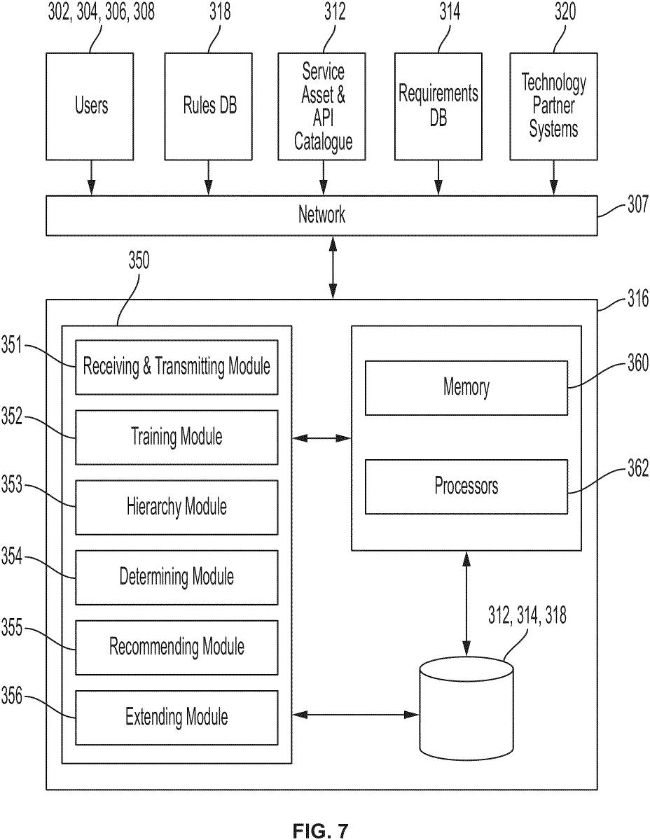

FIG. 7 depicts a schematic view of the cognitive integration engine 316 of the system for cognitive selection of composite services 300 of FIG. 5, in accordance with embodiments of the present invention. As shown, the cognitive integration engine 316 is connectable over a network 307 to various other devices and systems within the system 300. The cognitive integration engine 316 is shown connected via the network(s) 307 to the users 302, 304, 306, 308, the rules database 318, the service asset & API catalogue 312, the requirements database 314, and to various technology partner systems 320. These are all various potential connections between the cognitive integration engine 316. However, the cognitive engine may not require outside databases, and may store the information in the rules database 318, the service asset & API catalogue 312, and the requirements database 314, within the cognitive integration engine 316 itself, as shown. Further, the technology partner systems 320 may or may not communicate directly with the cognitive integration engine 316, but instead may provide information to the various databases 312, 314, 318 which then communicate the information to the cognitive integration engine 316.

The network(s) 50 may be any group of two or more computer systems linked together, and may include one or more separate networks. The network(s) 50 may represent, for example, the internet. The network(s) 50 may be any type of computer network known by individuals skilled in the art. Examples of computer networks which may be embodied by the network(s) 50 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the network(s) 50 may be a peer-to-peer network in some embodiments, wherein in other embodiments, the network(s) 50 may be organized as a client/server architecture.

Embodiments of the cognitive integration engine 316 may include a module structure 350 that includes a receiving and transmitting module 351, a training module 352, a hierarchy module 353, a determining module 354, a recommendation module 355, and an extending module 356. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the cognitive integration engine 316. A module (whether hardware, software, or a combination thereof) may be designed to implement or execute one or more particular functions or routines. The modules may each be separate components of the cognitive integration engine 316. In other embodiments, more than one module may be a single combined computer program, or hardware module. Moreover, the cognitive integration engine 316 may be a module portion of another computer system server, or computer infrastructure in some embodiments.

Embodiments of the receiving and transmitting module 351 may include one or more components of hardware and/or software program code for obtaining, retrieving, collecting, or otherwise receiving information from the users 302, 304, 306, 308, and the databases 312, 314, 318, as well as the technology partner systems 320 where appropriate, as well as transmitting thereto. The receiving module 351 may be configured to receive, for example, training inputs related to technology use cases and associated services as well as demands for composite services from a customer including functional and/or non-functional requirements.

Referring still to FIG. 1, embodiments of the computer system 120 may further include the training module 352. Embodiments of the training module 352 may include one or more components of hardware and/or software program code configured for training a cognitive model from received training inputs related to technology use cases and associated services. The training inputs may include at least functional and/or non-functional requirements, at least one list of available services, at least one list of planned services, at least one list of available application program interfaces (APIs), at least one list of planned APIs, and inputs for asset identification and prioritization. The training module 352 may further be configured for dynamically retraining the cognitive model based on an evolution of services as features and capabilities are added or changed to the services.

Embodiments of the hierarchy module 353 may include one or more components of hardware and/or software program code for generating a contextual technical services hierarchy for the customer, as shown in FIG. 4.

Embodiments of the determining module 354 may include one or more components of hardware and/or software program code for determining a selection of composite services for the customer based on the cognitive model.

Embodiments of the recommendation module 355 may include one or more components of hardware and/or software program code for recommending the selection of composite services to the customer, as well as recommending changes to existing service offerings or the creation of new service offerings based on customer demand information acquired and analyzed by the cognitive integration engine.

Embodiments of the extending module 356 may include one or more components of hardware and/or software program code for dynamically extending the cognitive model across an ecosystem of technology partners by integrating with exposed composite business or technical service assets of the technology partners.

Referring still to FIG. 7, embodiments of the cognitive integration engine 316 may be equipped with a memory device 360 and a processor 362. The memory device 360 may store the information needed by a processor 362 to perform operations thereof. The processor 362 may be configured for implementing the tasks associated with the cognitive integration engine 316, described hereinabove.

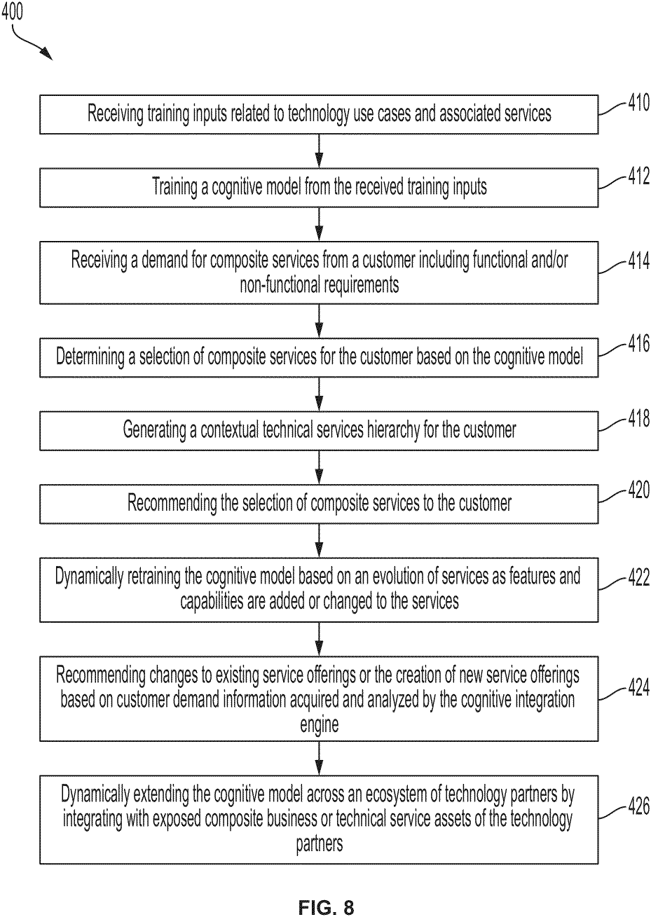

FIG. 8 depicts a method 400 for cognitive selection of composite services, in accordance with embodiments of the present invention. The method 400 includes a first step 402 of receiving, by one or more processors of a computer system, such as the system 300, training inputs related to technology use cases, such as the use cases 278, 202, 332, and associated services, such as the services 282, 284, 212, 222, 232, 242, 286, 288, 334, 336, 338, 340, 342, 344. The method 400 includes a next step 404 of training, by a cognitive integration engine such as the cognitive integration engine 316 of the one or more processors of the computer system, a cognitive model from the received training inputs. The training inputs for each technology use case may include at least functional and/or non-functional requirement, at least one list of available services, at least one list of planned services, at least one list of available application program interfaces (APIs), at least one list of planned APIs, and inputs for asset identification and prioritization. The training may further include generating the cognitive model using text analytics artificial intelligence and machine learning models.

The method 400 includes a further step 406 of receiving, by the one or more processors of the computer system, a demand for composite services from a customer, such as the customer 272, 274, 276, 280, 302, 308, including functional and/or non-functional requirements. The method 400 includes another step 408 of determining, by the cognitive integration engine of the one or more processors of the computer system, a selection of composite services for the customer based on the cognitive model. The method 400 still further includes a step 410 of generating, by the cognitive integration engine of the one or more processors of the computer system, a contextual technical services hierarchy for the customer. This step 410 may be included in the step 408 of determining the selection of composite services.

The method 400 further includes a step 412 of recommending, by the one or more processors of the computer system, the selection of composite services to the customer.

Still further, the method 400 includes a step 414 of dynamically retraining, by the cognitive integration engine of the one or more processors of the computer system, the cognitive model based on an evolution of services as features and capabilities are added or changed to the services. The method 400 further includes a step 416 of recommending, by the one or more computer processors of the computer system, changes to existing service offerings or the creation of new service offerings based on customer demand information acquired and analyzed by the cognitive integration engine. Finally, the method 400 is shown including the step 418 of dynamically extending, by the one or more processors of the computer system, the cognitive model across an ecosystem of technology partners by integrating with exposed composite business or technical service assets of the technology partners, such as the technology partners 320.

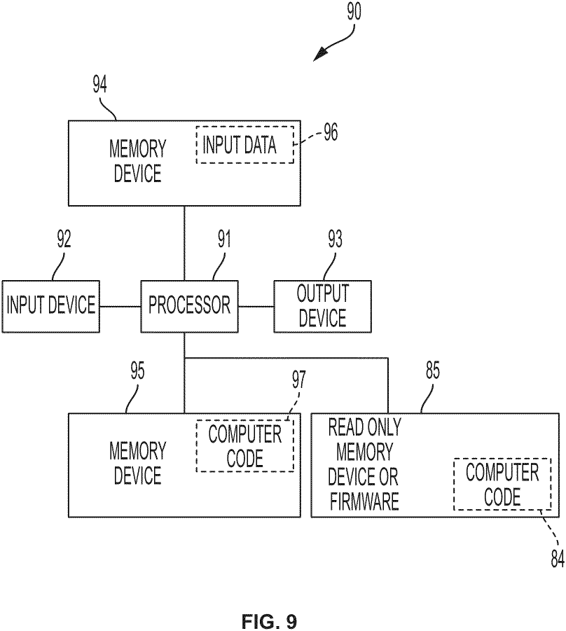

FIG. 9 depicts a block diagram of a computer system for the systems and engine of FIGS. 4, 5 and 7, capable of implementing methods such as those of FIGS. 1 and 8, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing methods for cognitive selection of composite services, in the manner prescribed by the embodiments of FIGS. 1 and 8 using the system for cognitive selection of composite services of FIGS. 4, 5 and 7, wherein the instructions of the computer code 597 may be executed by processor 591 via memory device 595. The computer code 597 may include software or program instructions that may implement one or more algorithms for implementing the methods for cognitive selection of composite services, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 9.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to systems and methods for cognitive selection of composite services. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to provide a system for cognitive selection of composite services. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for cognitive selection of composite services. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for cognitive selection of composite services.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

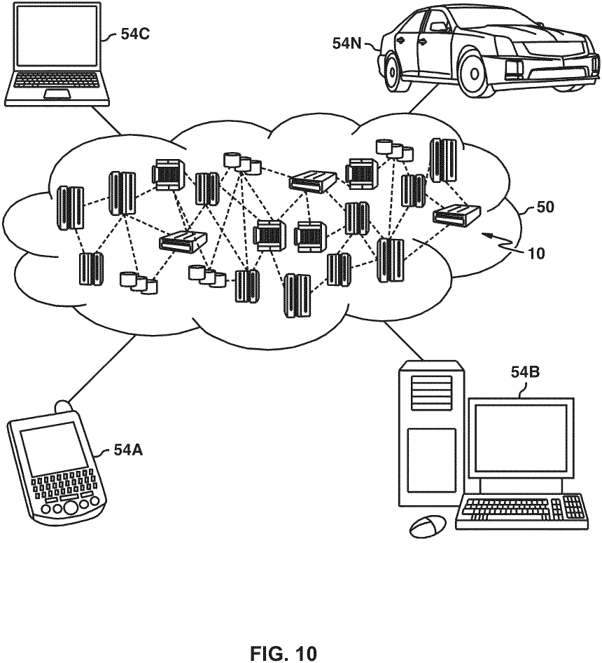

Referring now to FIG. 10, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 10 are intended to be illustrative only and that computing nodes 10 and cloud computing environment 50 can communicate with any type of computerized device over any type of network and/or network addressable connection (e.g., using a web browser).

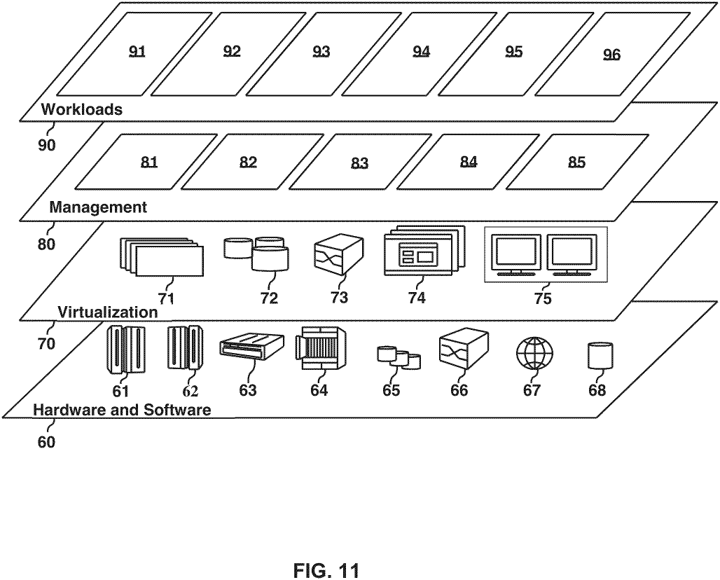

Referring now to FIG. 11, a set of functional abstraction layers provided by cloud computing environment 50 (see FIG. 10) is shown. It should be understood in advance that the components, layers, and functions shown in FIG. 11 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: sending and receiving 91; training 92; determining 93; recommending 94; retraining 95; and partner integration 96.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
receiving, by one or more processors of a computer system, training inputs related to technology use cases and associated services;
training, by a cognitive integration engine of the one or more processors of the computer system, a cognitive model from the received training inputs;
receiving, by one or more processors of a computer system, a demand for composite services from a customer including functional and/or non-functional requirements;
determining, by the cognitive integration engine of the one or more processors of the computer system, a selection of composite services for the customer based on the cognitive model; and
recommending, by the one or more processors of the computer system, the selection of composite services to the customer.

2. The method of claim 1, wherein the training inputs for each technology use case comprise:
at least functional and/or non-functional requirement;
at least one list of available services;
at least one list of planned services;
at least one list of available application program interfaces (APIs);
at least one list of planned APIs; and
inputs for asset identification and prioritization.

3. The method of claim 1, wherein the determining the selection of composite services for the customer based on the cognitive model further comprises:
generating, by the cognitive integration engine of the one or more processors of the computer system, a contextual technical services hierarchy for the customer.

4. The method of claim 1, further comprising:
dynamically retraining, by the cognitive integration engine of the one or more processors of the computer system, the cognitive model based on an evolution of services as features and capabilities are added or changed to the services.

5. The method of claim 1, further comprising:
recommending, by the one or more computer processors of the computer system, changes to existing service offerings or the creation of new service offerings based on customer demand information acquired and analyzed by the cognitive integration engine.

6. The method of claim 1, further comprising:
dynamically extending, by the one or more processors of the computer system, the cognitive model across an ecosystem of technology partners by integrating with exposed composite business or technical service assets of the technology partners.

7. The method of claim 1, wherein the cognitive integration engine generates the cognitive model using text analytics artificial intelligence and machine learning models.

8. A computer system, comprising:
one or more processors;
one or more memory devices coupled to the one or more processors; and
one or more computer readable storage devices coupled to the one or more processors,
wherein the one or more storage devices contain program code executable by the one or more processors via the one or more memory devices to implement a method for cognitive selection of composite services, the method comprising:
receiving, by the one or more processors of the computer system, training inputs related to technology use cases and associated services;
training, by a cognitive integration engine of the one or more processors of the computer system, a cognitive model from the received training inputs;
receiving, by one or more processors of a computer system, a demand for composite services from a customer including functional and/or non-functional requirements;
determining, by the cognitive integration engine of the one or more processors of the computer system, a selection of composite services for the customer based on the cognitive model; and
recommending, by the one or more processors of the computer system, the selection of composite services to the customer.

9. The computer system of claim 8, wherein the training inputs for each technology use case comprise:
at least functional and/or non-functional requirement;
at least one list of available services;
at least one list of planned services;
at least one list of available application program interfaces (APIs);
at least one list of planned APIs; and
inputs for asset identification and prioritization.

10. The computer system of claim 8, wherein the determining the selection of composite services for the customer based on the cognitive model further comprises:
generating, by the cognitive integration engine of the one or more processors of the computer system, a contextual technical services hierarchy for the customer.

11. The computer system of claim 8, the method further comprising:
dynamically retraining, by the cognitive integration engine of the one or more processors of the computer system, the cognitive model based on an evolution of services as features and capabilities are added or changed to the services.

12. The computer system of claim 8, the method further comprising:
recommending, by the one or more computer processors of the computer system, changes to existing service offerings or the creation of new service offerings based on customer demand information acquired and analyzed by the cognitive integration engine.

13. The computer system of claim 8, the method further comprising:
dynamically extending, by the one or more processors of the computer system, the cognitive model across an ecosystem of technology partners by integrating with exposed composite business or technical service assets of the technology partners.

14. The computer system of claim 8, wherein the cognitive integration engine generates the cognitive model using text analytics artificial intelligence and machine learning models.

15. A computer program product for cognitive selection of composite services, the computer program product comprising:
one or more computer readable storage media having computer readable program code collectively stored on the one or more computer readable storage media, the computer readable program code being executed by one or more processors of a computer system to cause the computer system to perform a method comprising:
receiving, by the one or more processors of the computer system, training inputs related to technology use cases and associated services;
training, by a cognitive integration engine of the one or more processors of the computer system, a cognitive model from the received training inputs;
receiving, by one or more processors of a computer system, a demand for composite services from a customer including functional and/or non-functional requirements;
determining, by the cognitive integration engine of the one or more processors of the computer system, a selection of composite services for the customer based on the cognitive model; and
recommending, by the one or more processors of the computer system, the selection of composite services to the customer.

16. The computer program product of claim 15, wherein the training inputs for each technology use case comprise:
at least functional and/or non-functional requirement;
at least one list of available services;
at least one list of planned services;
at least one list of available application program interfaces (APIs);
at least one list of planned APIs; and
inputs for asset identification and prioritization.

17. The computer program product of claim 15, wherein the determining the selection of composite services for the customer based on the cognitive model further comprises:
generating, by the cognitive integration engine of the one or more processors of the computer system, a contextual technical services hierarchy for the customer.

18. The computer program product of claim 15, the method further comprising:
dynamically retraining, by the cognitive integration engine of the one or more processors of the computer system, the cognitive model based on an evolution of services as features and capabilities are added or changed to the services.

19. The computer program product of claim 15, the method further comprising:
recommending, by the one or more computer processors of the computer system, changes to existing service offerings or the creation of new service offerings based on customer demand information acquired and analyzed by the cognitive integration engine.

20. The computer program product of claim 15, the method further comprising:
dynamically extending, by the one or more processors of the computer system, the cognitive model across an ecosystem of technology partners by integrating with exposed composite business or technical service assets of the technology partners.
